(19) United States
(12) Patent Application Publication
(10) Pub. No.: US 2006/0277985 A1
(43) Pub. Date: Dec. 14, 2006

(54) Blind hole plug-in wheel speed sensor

(76) Inventor: Steven E. Faetanini, Sandusky, OH (US)

Correspondence Address: DELPHI TECHNOLOGIES, INC., M/C 480-410-202, PO BOX 5052, TROY, MI, 48007, US

(21) Appl. No.: 11/151,034

(22) Filed: Jun. 13, 2005

(51) Int. Cl. G01L 5/28

(52) U.S. Cl. 73/121

(57) ABSTRACT

A sensor assembly (10) for measuring a speed of a movable member. The sensor assembly (10) includes an enclosure (28) defining a cavity (30). The cavity (30) is defined by a blind hole extending into the enclosure (28). The enclosure (28) is positioned so as to be substantially stationary relative to the movable member. A sensor element (36) is received within the cavity (30) and is disposed to sense movement of the movable member. When the sensor element (36) is received within the cavity (30), a portion of the enclosure (28) is interposed between the sensor element (36) and the movable member. A seal (38) is operatively coupled to the sensor element (36) for substantially excluding contaminants from the cavity (30). A securement mechanism may be provided comprising a latch member (44) coupled to one of the sensor element (36) and the enclosure (28), and a complementary locking tab (46) coupled to the other one of the sensor element (36) and the enclosure (28) for engaging the latch member (44) to secure the sensor element (36) within the cavity (30). In a particular embodiment, a sensor assembly (10) as described herein is incorporated into a wheel bearing assembly (12) including a non-rotatable member (14) and a rotatable member (16) rotatably coupled to the non-rotatable member. In this embodiment, the sensor assembly (10) is coupled to the non-rotatable member (14) so as to be substantially stationary relative to the rotatable member (16).

### BACKGROUND OF THE INVENTION

The present invention relates generally to vehicles, and more particularly to a vehicle wheel speed sensor assembly adapted for mounting on a wheel bearing.

Vehicles include automotive vehicles having conventional wheel bearings wherein each wheel bearing includes a non-rotatable member (such as a bearing hub), a rotatable member (such as a bearing spindle) rotatably attached to the non-rotatable member, and wheel studs (also called stud bolts). The non-rotatable member typically is attached to a vehicle suspension system component. The stud bolt is press-fitted into a through hole of a spindle flange. A vehicle wheel is placed on the stud bolts and secured by wheel nuts (also called lug nuts).

Wheel speed sensors systems may be incorporated into the vehicle for measuring the rotational speed of the vehicle wheel. Components of these sensor systems may be mounted on elements of the wheel bearings. For example, probe type sensors may be mounted to end caps attached to end portions of the bearings. This type of sensor offers the benefits of an integral wheel speed sensor with enhanced serviceability. An end cap is pressed into the inboard end of the bearing. The end cap features a through hole extending into a portion of the bearing where the target ring is mounted. This through hole allows the sensor end face to be located close to the face of the target wheel. A seal (for example, an O-ring) is positioned at a junction between the end cap and the sensor to exclude contaminants from the bearing interior. A fastener is used to secure the probe sensor to the end cap.

One problem with such designs arises from the through hole in the end cap. The O-ring seal must be located properly during assembly. If the O-ring is missing or improperly installed, it can allow contaminants to enter the bearing. Another problem arises from the separate fastener. If the fastener is improperly tightened during installation, the O-ring may not be properly seated, resulting in an inadequate seal. Improper tightening of the fastener may also result a skewing or cocking of the sensor, thereby interfering with proper operation of the sensor. The separate fastener also increases the cost and complexity of the sensor system assembly operation.

### SUMMARY OF THE INVENTION

The problems set forth above are addressed by the sensor assembly of the present invention. In addition, other advantages of the present invention will be readily apparent to one of ordinary skill in the art.

The present invention provides a sensor assembly for measuring a speed of a movable member. The sensor assembly includes an enclosure defining a cavity. The cavity is defined by a blind hole extending into the enclosure. The enclosure is positioned so as to be substantially stationary relative to the movable member. A sensor element is received within the cavity and is disposed to sense movement of the movable member. When the sensor element is received within the cavity, a portion of the enclosure is interposed between the sensor element and the movable member. In addition, a seal is operatively coupled to the sensor element for substantially excluding contaminants from the cavity. A securement mechanism may be provided comprising a latch member coupled to one of the sensor element and the enclosure, and a complementary locking tab coupled to the other one of the sensor element and the enclosure, for engaging the latch member to secure the sensor element within the cavity.

In a particular embodiment, a sensor assembly in accordance with the present invention is incorporated into a wheel bearing assembly including a non-rotatable member and a rotatable member rotatably coupled to the non-rotatable member. In this embodiment, the sensor assembly is coupled to the non-rotatable member so as to be substantially stationary relative to the rotatable member.

### BRIEF DESCRIPTION OF THE DRAWINGS

In the drawings illustrating embodiments of the present invention:

FIG. 1 is a cross-sectional side view of one embodiment of a wheel bearing assembly incorporating a sensor assembly in accordance with the present invention;

FIG. 2 is a perspective view of the wheel bearing assembly shown in FIG. 1;

FIG. 3 is a perspective view of a sensor element incorporated into a sensor element housing in accordance with the present invention;

FIG. 4 is a perspective view of an enclosure incorporated into a bearing end cap in accordance with the present invention; and

FIG. 5 is a partial cross-sectional view of the wheel bearing assembly shown in FIG. 1.

### DETAILED DESCRIPTION

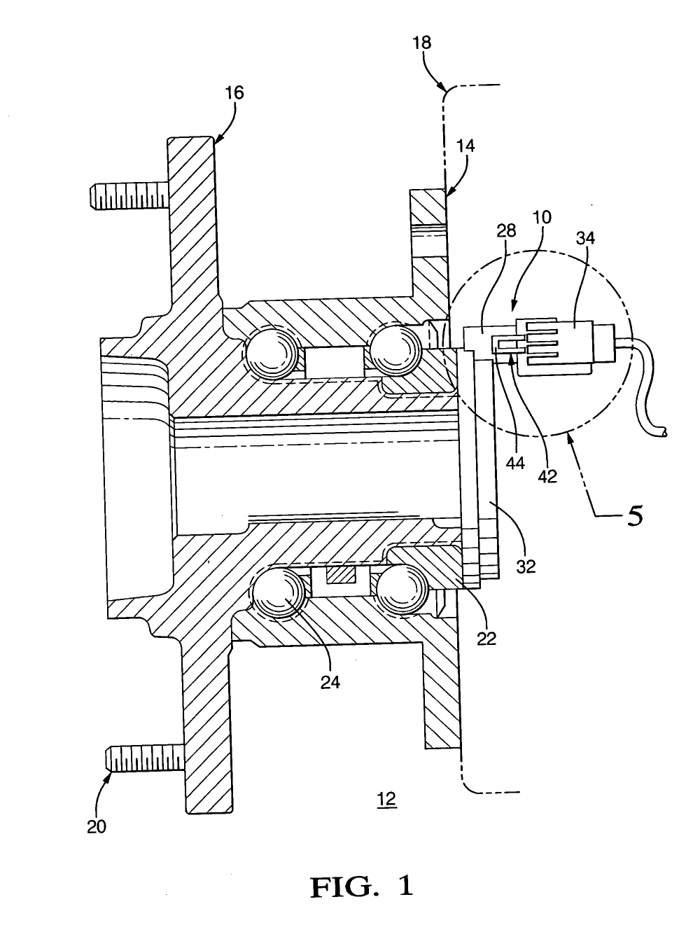

Referring now to the drawings, FIGS. 1-5 illustrate a first embodiment of the present invention. The present invention provides a sensor assembly, generally designated 10, for measuring a speed of a movable member.

In the embodiment shown in FIG. 1, sensor assembly 10 is shown incorporated into a vehicle wheel bearing assembly 12 (for example, as an element in an anti-lock braking system (ABS)), for measuring the rotational speed of a wheel (not shown). Referring to FIG. 1, wheel bearing assembly 12 comprises a non-rotatable member 14, a rotatable member 16 rotatably coupled to non-rotatable member 14, and sensor assembly 10. Typically, vehicle wheel bearing assembly 12 includes inboard and outboard seals (omitted from FIG. 1 for clarity) protecting the bearing cavity.

In the embodiment shown in FIG. 1, non-rotatable member 14 is in the form of a bearing mount for mounting to a vehicle suspension system knuckle 18. Non-rotatable member 14 may, for example, be bolted to knuckle 18 (using the same bolt holes used for attaching the knuckle to a strut). Alternatively, the non-rotatable member 14 may be press-fit onto knuckle 18.

In the embodiment shown in FIG. 1, rotatable member 16 is in the form of a wheel spindle attached to a drive (or non-drive) shaft (not shown in FIG. 1), and on which a vehicle wheel (not shown) is mounted. Wheel studs 20 are attached to rotatable member 16 of the bearing assembly 12, and the wheel is attached to wheel studs 20 by using lug nuts (not shown). Spindle 16 includes an inboard inner race 22, and other races are formed by portions of non-rotatable member 14 and rotatable member 16 to provide inboard and outboard raceways for bearing rolling elements 24. Any one of several types of rolling elements (ball, cylinder, etc.) may be used. Alternatively, other types of bearings (for example, magnetic bearings) may be used. In another non-limiting example, the spindle is the non-rotating member and the bearing mount is the rotating member.

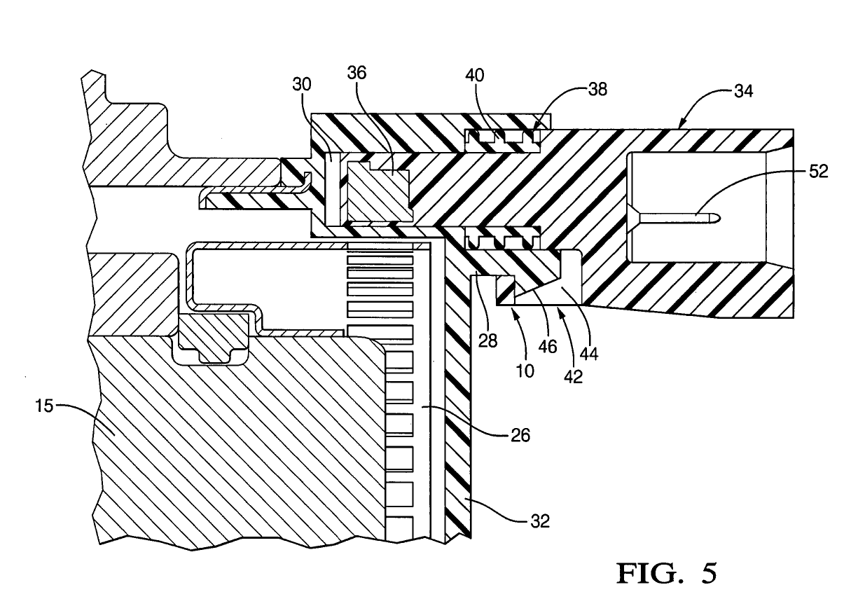

Referring to FIG. 5, a target ring 26 is coupled to rotatable member 16 so as to rotate in conjunction with the wheel. In FIG. 5, target ring 26 is shown attached to a rotatable shaft 15. However, ring 26 may alternatively be attached directly to movable member 16 or to any other element configured to rotate in conjunction with the vehicle wheel. Depending on the type of sensor element used, target ring 26 may comprise for example, a toothed wheel or a magnetic encoder wheel affixed, for example, to a shaft 15 extending through a central opening in rotatable member 16.

Referring to FIGS. 1-5, sensor assembly 10 includes an enclosure 28 defining a cavity 30 for receiving a sensor element 36 therein. Enclosure 28 is coupled to non-rotatable member 14 so as to be substantially stationary relative to the wheel whose speed is to be measured. In the embodiment shown in FIGS. 1-5, enclosure 28 is incorporated into a cap 32 affixed (for example, using an interference fit) to an end portion of bearing assembly 12. In the embodiment shown in FIGS. 1-5, cavity 30 comprises a blind hole extending into enclosure 28 and located along cap 32 such that sensor 36 element received within cavity 30 is disposed to sense rotational movement of the wheel by sensing the rotation of target ring 26 coupled to rotatable member 16.

In the embodiment shown in FIG. 1, enclosure 36 and cap 32 are formed as a monolithic structure from a material having a very low magnetic permeability and retentivity, such as a polymer material, to prevent the disruption or distortion of magnetic field variations resulting from movement of target ring 26, and which are detected by sensor element 36. As used herein, the term “magnetic permeability’ refers to the ability of a substance to become magnetized in the presence of a relatively weak magnetic field. Also as used herein, the term “retentivity” refers to the capacity of a body to remain magnetized after a magnetizing field has ceased to exert an effect on the body.

Enclosure 28 is not limited to attachment to a non-rotatable section of a vehicle wheel bearing. In one example (not shown), enclosure 28 is attached to a non-bearing vehicle member, such as a portion of the vehicle frame.

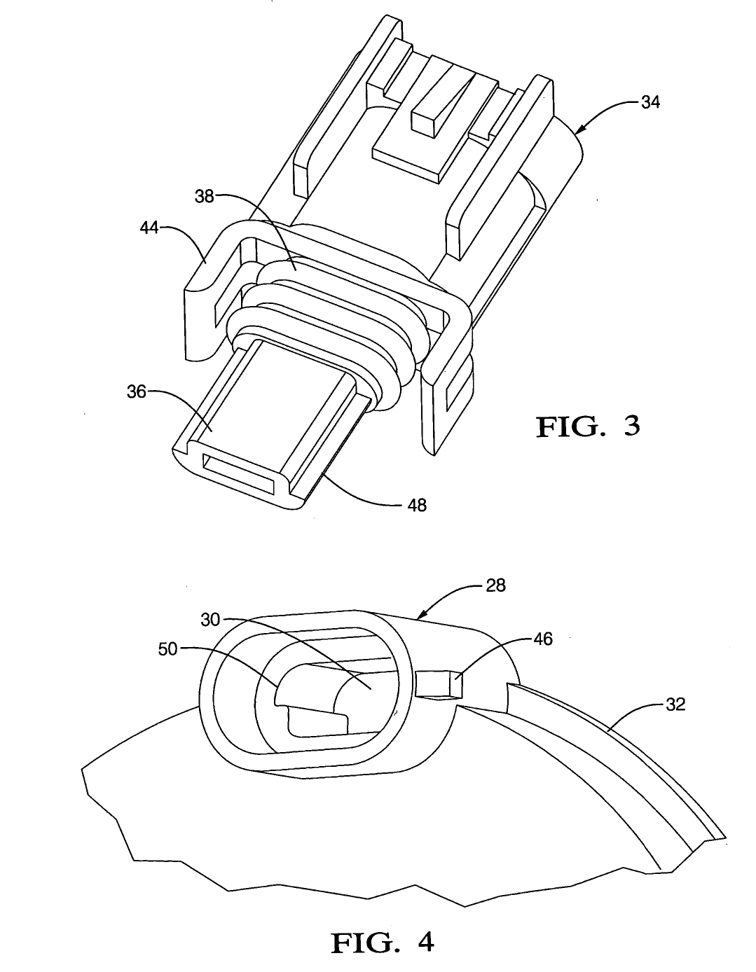

Referring again to FIGS. 3 and 5, a sensor element 36 is received and secured within cavity 30 of enclosure 28. Any one of a variety of known sensor types may be used, for example, a magnetoresistive sensor, a Hall effect sensor, or a variable reluctance sensor. In a further non-limiting example, the sensor element comprises an optical sensor. The particular type of target ring and the particular type of sensor element used are determined according to design requirements.

As seen in FIG. 5, when sensor element 36 is received in cavity 30, a portion of enclosure 28 is interposed between sensor element 36 and target ring 26 coupled to rotatable member 16. Sensor element 36 may be positioned within cavity 30 so as to abut the portion of enclosure 28 interposed between the sensor element and the target ring. In this case, enclosure 28 forms a positive stop against which sensor element 36 may rest, enabling a relatively high degree of control over the air gap separating sensor element 36 from target ring 26.

Referring again to FIGS. 1-5, in a particular embodiment, the sensor element is molded into a sensor element housing 34. Housing 34 is formed from a material having a very low magnetic permeability and retentivity, such as a polymer material, to prevent the disruption or distortion of a magnetic field or variations in the magnetic field produced by movement of rotatable member 16, and which are detected by sensor element 36. In the embodiment shown in FIGS. 1-5, sensor element 36 is positioned adjacent target ring 26 and spaced radially outwardly from target ring 26. The operation of a sensor element in conjunction with a target ring for a vehicle wheel speed sensor, such as an anti-lock-braking-system (ABS) wheel speed sensor, is well known.

Referring again to FIGS. 3 and 5, a resilient seal 38 is positioned along sensor element 36 for excluding contaminants from cavity 30. In the embodiment shown in FIGS. 3 and 5, seal 38 is an elastomeric seal including a plurality of resilient ribbed portions 40. As seen in FIG. 5, ribbed portions 40 engage an inner wall of enclosure 28 when sensor element 36 is inserted into enclosure 28, thereby forming a seal against incursion by contaminants entering the opening of cavity 30.

Referring again to FIGS. 1-5, a securement mechanism, generally designated 42, is provided for securing sensor element 36 within cavity 30. In the embodiment shown in FIGS. 1-5, securement mechanism 42 comprises one or more latch members 44 positioned along sensor element housing 34 containing sensor element 36. Complementary locking tabs 46 are positioned along surfaces of enclosure 28 for engaging latch members 44 to secure sensor element 36 within cavity 30. Latch members 44 may be formed from a polymer and molded simultaneously with sensor element housing 34 to form a monolithic structure, as shown in FIGS. 1-5. Alternatively, latch members 44 may be formed separately from housing 34 and attached to housing 34 using any of a variety of means, such as adhesives or ultrasonic welding. In another alternative embodiment (not shown), latch members are positioned along surfaces of enclosure 28, and complementary locking tabs are positioned along surfaces of sensor element 36.

Referring again to FIGS. 3 and 4, sensor element housing 34 also includes a keying system for properly orienting sensor element 36 within enclosure cavity 30. In the embodiment shown in FIGS. 3 and 4, a key 48 is formed along an outer surface of sensor element housing 34 and a complementary slot 50 is formed along an inner surface of enclosure 28 for engaging key 48 to orient sensor element 36 within cavity 30. Alternatively, a key may be formed along an inner surface of the enclosure and a complementary slot may be formed along an outer surface of the sensor element housing 34 for engaging the key to orient the sensor element within the cavity.

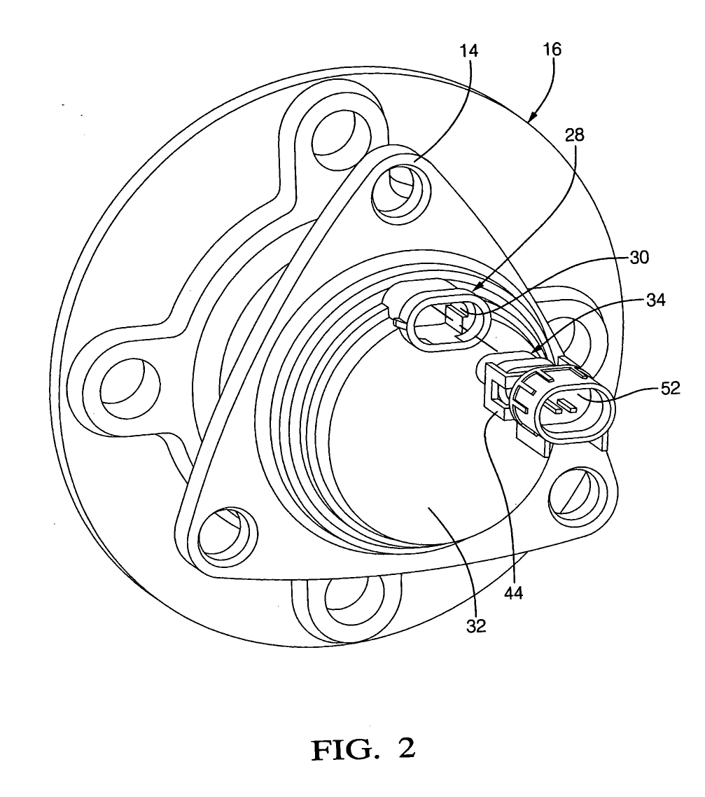

In the embodiment shown in FIGS. 2 and 5, an electrical connector 52 is permanently attached to sensor element housing 34. Connector 52 is electrically connected to sensor element 36 and adapted for electrical connection to a cable (not shown), such as a computer cable. As used herein, the term “permanently attached” means that electrical connector 52 cannot be detached from the sensor element housing 34 without damaging the electrical connector or the sensor element housing, or both. As used herein, the term “computer cable” refers to any wire coming from a system or module which operates as a computer. It is also noted that any one of a variety of electrical connector types may be used including, without limitation, plug-type connectors and receptacle-type connectors.

In the embodiment shown in FIGS. 2 and 5, electrical connector 52 is molded into sensor element housing 34. In an alternative embodiment (not shown), electrical connector 52 is attached to the sensor element housing in a manner (e.g., using screws) which allows detachment without damage to the electrical connector and/or the sensor element housing. In another alternative embodiment (not shown), electrical connector 52 is attached to the sensor element housing through an intervening element, such as a gasket and/or a quantity of adhesive. In yet another alternative embodiment (not shown), the electrical connector is eliminated and a cable electrically connected to the sensor element is incorporated into the sensor element housing.

In yet another alternative embodiment (not shown), electrical connector 52 is internally electrically connected to sensor element 36, meaning that the wire connection is not exposed from outside the assembled sensor mechanism assembly 20. In another construction (not shown), at least a portion of the wire connection is external, meaning that the connecting wire or wire portion is exposed from outside the assembled sensor mechanism assembly. Finally, the wire or cable to which electrical connector 52 is adapted for electrical connection is not limited to a vehicle computer cable. In one example (not shown), the vehicle wire is a speedometer wire. Other examples are also contemplated.

In one method of assembling the wheel bearing assembly, the vehicle wheel bearing 10 is brought as an assembled unit to have its non-rotatable member 14 attached to the vehicle suspension system knuckle 18. Then, cap 32 is attached to an end portion of bearing assembly 12. Sensor element 36 is then secured in enclosure cavity 30, and (if required) a computer cable is connected to electrical connector 52. Finally, a vehicle wheel (not shown) is attached to wheel studs 20.

Alternative methods of assembly are also contemplated, depending on such factors as the particular configurations of the individual elements of the sensor and bearing assemblies. In addition, while sensor element 36 directly or indirectly senses wheel rotation, the sensor element is not limited to sensing rotation of either a target ring or a target ring attached to a rotatable section of the vehicle wheel bearing.

The present invention addresses the bearing sealing problem previously described by using a blind hole in the bearing end cap. In addition, the use of an integral securement system eliminates the need for a separate fastener. Also, the keying features of the present invention serve to orient the sensor element within the enclosure cavity, while imparting additional stiffness to the sensor element housing, thereby aiding in resisting vibrations encountered during use. Furthermore, the elastomeric seal keeps contaminants out of the enclosure cavity, thus eliminating the need to completely seal the sensor element. This allows the sensor element to be positioned relatively close the target ring while enabling a relatively high degree of control over the size of the air gap between the sensor element and the target ring.

The foregoing description of several expressions of embodiments of the invention has been presented for purposes of illustration. It is not intended to be exhaustive or to limit the invention to the precise form disclosed, and obviously many modifications and variations are possible in light of the above teaching. It is intended that the scope of the invention be defined by the claims appended hereto.

1. A sensor assembly for measuring a speed of a movable member, the sensor assembly comprising:
an enclosure defining a cavity, the enclosure being positioned so as to be substantially stationary relative to the movable member;
a sensor element received within the cavity, the sensor element being disposed to sense movement of the movable member, a portion of the enclosure being interposed between the sensor element and the movable member; and
a seal operatively coupled to the sensor element for substantially excluding contaminants from the cavity.

2. The sensor assembly of claim 1 wherein the enclosure is a sensor element housing containing the sensor element.

3. The sensor assembly of claim 1 further comprising a securement mechanism for securing the sensor element within the cavity.

4. The sensor assembly of claim 3 wherein the securement mechanism comprises a latch member coupled to one of the sensor element and the enclosure, and a locking tab coupled to the other one of the sensor element and the enclosure for engaging the latch member to secure the sensor element within the cavity.

5. The sensor assembly of claim 4 further comprising a sensor element housing containing the sensor element, and wherein the sensor element housing and one of the locking tab and the latch member define a monolithic structure.

6. The sensor assembly of claim 1 further comprising a sensor element housing containing the sensor element, and wherein the sensor element is molded into the sensor element housing.

7. The sensor assembly of claim 1 further comprising a sensor element housing containing the sensor element, the sensor element housing also including an electrical connector electrically connected to the sensor element and adapted for electrical connection to a computer cable.

8. The sensor assembly of claim 7 wherein the electrical connector is molded into the sensor element housing.

9. The sensor assembly of claim 7 wherein the sensor element is molded into the sensor element housing.

10. The sensor assembly of claim 1 further comprising a sensor element housing containing the sensor element, the sensor element housing also including a cable electrically connected to the sensor element.

11. The sensor assembly of claim 1 further comprising a sensor element housing containing the sensor element, a first keying element formed on one of the sensor element housing and the enclosure, and a second keying element formed on the other one of the sensor element housing and the enclosure for engaging the first keying element to orient the sensor element within the cavity.

12. The sensor assembly of claim 1 wherein the cavity is a blind hole extending into the enclosure.

13. The sensor assembly of claim 1, wherein the sensor element is an anti-lock-braking-system (ABS) wheel speed sensor.

14. The sensor assembly of claim 1 wherein the seal is an elastomeric seal.

15. A wheel bearing assembly comprising:
a non-rotatable member;
a rotatable member rotatably coupled to the non-rotatable member; and
a sensor assembly including:
an enclosure coupled to the non-rotatable member so as to be substantially stationary relative to the rotatable member, the enclosure defining a cavity;
a sensor element received within the cavity, the sensor element being disposed to sense rotation of the rotatable member;
a portion of the enclosure being interposed between the sensor element and the rotatable member; and
a seal operatively coupled to the sensor element for substantially excluding contaminants from the cavity.

16. The wheel bearing assembly of claim 15, wherein the non-rotatable member is a bearing hub.

17. The wheel bearing assembly of claim 15, wherein the rotatable member is a bearing spindle.

18. The wheel bearing assembly of claim 15, wherein the sensor assembly further comprises a target ring coupled to the rotatable member so as to rotate in conjunction with a wheel.

19. The wheel bearing assembly of claim 18 wherein the target ring comprises a toothed wheel.

20. The wheel bearing assembly of claim 18 wherein the target ring comprises a magnetic encoder wheel.

21. The wheel bearing assembly of claim 20 wherein the sensor element comprises a magnetoresistive sensor.

22. The wheel bearing assembly of claim 15 wherein the sensor element comprises a Hall effect sensor.

23. The wheel bearing assembly of claim 15 wherein the sensor element comprises a variable reluctance sensor.

24. The wheel bearing assembly of claim 15 wherein the enclosure is incorporated into a member which is affixed to the non-rotatable member.
